(19) United States
(12) Patent Application Publication
(10) Pub. No.: US 2021/0238367 A1
(43) Pub. Date: Aug. 5, 2021

(54) PROCESS FOR PREPARING A BONDING RESIN

(71) Applicant: Stora Enso OYJ, Helsinki (FI)

(72) Inventors: Ben Nasli Bakir, Saltsjö-Boo (SE); Ashar Zafar, Älta (SE); Jesper Ekström, Johanneshov (SE)

(73) Assignee: Stora Enso OYJ, Helsinki (FI)

(21) Appl. No.: 17/048,713

(22) PCT Filed: Apr. 16, 2019
(86) PCT No.: PCT/IB2019/053097

§ 371 Date: Oct. 19, 2020

(30) Foreign Application Priority Data
Apr. 20, 2018 (SE) 1850468-8

(51) Int. Cl. C08J 3/00; B27N 3/00; B27N 3/12; B27N 1/00; C09J 161/06; C09J 197/00; C08K 5/21

(52) U.S. Cl. CPC C08J 3/005; B27N 3/002; B27N 3/12; B27N 1/003; C08J 2361/06; C09J 197/005; C08K 5/21; C08J 2397/00; C09J 161/06

(57) ABSTRACT

The present invention relates to a process for preparing a bonding resin, wherein a resin prepared from lignin, phenol and formaldehyde and comprising a formaldehyde scavenger, is mixed with a resin prepared from phenol and formaldehyde and comprising a formaldehyde scavenger to achieve a mixture useful as a bonding resin useful in the manufacture of oriented strand board (OSB).

### FIELD OF THE INVENTION

The present invention relates to a process for preparing a bonding resin, wherein a resin prepared from lignin, phenol and formaldehyde is mixed with a resin prepared from phenol and formaldehyde to achieve a mixture useful as a bonding resin useful in the manufacture of oriented strand board (OSB).

### BACKGROUND

Lignin, an aromatic polymer is a major constituent in e.g. wood, being the most abundant carbon source on Earth second only to cellulose. In recent years, with development and commercialization of technologies to extract lignin in a highly purified, solid and particularized form from the pulp-making process, it has attracted significant attention as a possible renewable substitute to primarily aromatic chemical precursors currently sourced from the petrochemical industry.

Lignin, being a polyaromatic network has been extensively investigated as a suitable substitute for phenol during production of phenol-formaldehyde adhesives. These are used during manufacturing of structural wood products such as plywood, oriented strand board and fiberboard. During synthesis of such adhesives, phenol, which may be partially replaced by lignin, is reacted with formaldehyde in the presence of either basic or acidic catalyst to form a highly cross-linked aromatic resins termed novolacs (when utilizing acidic catalysts) or resoles (when utilizing basic catalysts). Currently, only limited amounts of the phenol can be replaced by lignin due to the lower reactivity of lignin.

One problem when preparing resins comprising lignin is to optimize the properties of the final resin for different products. In an industrial setting, it is essential to be able to quickly adapt the properties of resins, to ensure optimal performance of the resins in the manufacture of the final products. At the same time, it is desirable to use as much lignin, a renewable material, as possible in the resins and at the same time minimize the use of phenol. Since resins need to have different properties depending on end product, numerous different resins, i.e. individual resins having different properties, need to be produced and sometimes stored, to allow the production of a range of final end products. Significant storage space may be required, alternatively different types of resin recipes need to be used either in parallel, requiring additional mixing equipment, or serially which requires cleaning of reaction vessels between resin batches and a risk that when production requirements change, the resin preparation is too slow and is unable to meet the needs of the required end use, thereby reducing overall efficiency of production of final products and thereby a significant cost increase of such production.

### SUMMARY OF THE INVENTION

It has now surprisingly been found that it is possible to optimize the properties of a resin mixture without producing a separate resin for each intended use. Instead, a first resin and a second resin is prepared, optionally stored, and then mixed in a ratio adapted to achieve defined and required resin properties. Thereby, the speed of production of products manufactured using resins, and particularly the efficiency of shifting between producing resins having properties adapted for different such products, can be significantly improved.

The present invention is thus directed to a method for preparing a resin in the form of a mixture comprising the steps of
a) preparing a first resin comprising lignin, phenol, formaldehyde and a formaldehyde scavenger;
b) preparing a second resin comprising phenol, formaldehyde and a formaldehyde scavenger, wherein the second resin comprises less than 1 wt-% lignin, by weight of the second resin;
c) mixing the first resin and the second resin in a weight ratio of from 0.5:10 to 10:0.5 based on weight of the mixture of the first resin and second resin.

The first resin can be prepared using methods known in the art. For example, lignin can be dissolved into an aqueous medium comprising alkali. The dissolution of the lignin may be carried out with or without heating. In a subsequent step, phenol, formaldehyde and a formaldehyde scavenger is added to the solution during or at the end of the reaction, separately or simultaneously. The reaction mixture is heated to approximately 40-95° C. until the reaction is completed and desirable properties, such as viscosity, have been achieved. The amount of lignin used in the preparation of the resin is typically such that lignin has replaced phenol to a replacement level of 5-95% in the first resin used in the context of the present invention. Thus, the lignin reacts during the preparation of the first resin.

Preferably, the formaldehyde scavenger is urea, ammonia or a mixture thereof.

Lignin may be utilized as a powder at the time that it is incorporated into the resin formulation. Lignin can also be utilized in “liquid form” in an alkali solution or as a dispersion in order to avoid lignin dust.

The second resin can be prepared using methods known in the art. There is essentially no lignin used in the preparation of the second resin. However, for practical purposes, small amounts of lignin may be present since a reaction vessel which has previously been used to prepare the first resin may be used also in the preparation of the second resin. For example, phenol and formaldehyde may be mixed in an aqueous medium, optionally in the presence of alkali, the phenol and formaldehyde being added separately or simultaneously to the liquid medium. The reaction mixture is heated to approximately 40-95° C. until the reaction is completed and desirable properties, such as viscosity, have been achieved. A formaldehyde scavenger can be added during or at the end of the reaction.

The first resin and the second resin may be prepared in any order prior to being mixed with each other.

The step of mixing the first resin and the second resin can be carried out at room temperature. However, it is preferable to carry out the mixing step at a temperature of from 20° C. to 35° C. The mixing can be carried using traditional mixing equipment and the mixing can be carried out batch-wise or continuously. The mixing is preferably carried out such that the stirring is performed at less than 10000 rpm, more preferably in the range of from 10 to 5000 rpm, such as from 10 to 1000 rpm, particular 20 to 500 rpm. The mixing is typically carried out for at least one minute, such as from 1 minute to 2 hours, depending on the volume of the mixture being prepared.

When mixing the first resin and the second resin, the viscosity of the mixture of the first resin and the second resin is preferably monitored, either on a continuous basis or by taking samples at defined time intervals.

The amount of each of the first resin and the second resin that is added to provide the mixture of the first resin and the second resin depends on the intended use of the mixture and the required properties necessary for that use. Typically, the amount of each of the first resin and second resin is added according to a predetermined recipe such that the mixture of the first resin and the second resin yields the desired properties.

The step of mixing the first resin and the second resin is carried out until the first resin and the second resin have been adequately mixed, such that the composition of the mixture is essentially homogenous throughout the mixture obtained.

In step c) or in a subsequent step, the properties of the mixture of the first resin and the second resin can be adjusted by adding additives to the mixture. Such additives are for example acids or bases, to adjust the pH of the mixture of the first resin and the second resin to a desired pH. The additives may also be colorants, pigments, fire retardants or other additives typically used in the preparation of resins.

The present invention is thus also directed to the use of the mixture of the first resin and the second resin in the manufacture of oriented strand board (OSB). The present invention is also directed to such oriented strand board manufactured using the mixture of the first resin and the second resin.

The present invention is also directed to a method for selecting an optimized resin mixture for a specific end use, comprising the steps of
a) defining desirable properties of a resin;
b) preparing a first resin comprising lignin, phenol, formaldehyde and a formaldehyde scavenger;
c) preparing a second resin comprising phenol, formaldehyde and a formaldehyde scavenger, wherein the second resin comprises less than 1 wt-% lignin, by weight of the second resin;
d) mixing the first resin and the second resin in a defined weight ratio of from 0.5:10 to 10:0.5 based on weight of the mixture of the first resin and second resin;
e) in an empty vessel, repeating step d) with a different weight ratio;
f) repeating step e) at least five times with additional different weight ratios in step d) in each repetition;
g) evaluating the properties of each mixture of the first resin and the second resin, said evaluation being carried out based on the properties of the resin as such or based on the properties of a final product prepared using each mixture of the first resin and the second resin obtained in step f);
h) selecting the optimized mixture of the first resin and the second resin obtained in step f), based on the results of the evaluation carried out in step g), said selection step comprising the determination of which mixture of the first resin and second resin obtained in step f) has properties closest to the desired properties of a resin defined in step a).

The evaluation of the properties if the resin mixture or product manufactured using the resin mixture can be carried out using methods known in the art. Examples of such properties of the resin include viscosity, pH, storage time, solid content etc and of the product manufactured using the resin include pressing time, assembly time, reactivity etc. The properties concerned can be determined by the skilled person.

### DETAILED DESCRIPTION

It is intended throughout the present description that the expression “lignin” embraces any kind of lignin, e.g. lignin originated from hardwood, softwood or annular plants. Preferably the lignin is an alkaline lignin generated in e.g. the Kraft process. The lignin may then be separated from the black liquor by using the process disclosed in WO2006031175.

The pH of the mixture of the first resin and the second resin may be adjusted by addition of acid or base, depending on the final use of the mixture of the first resin and the second resin. To the extent alkali is added, it is preferably sodium hydroxide, potassium hydroxide, calcium hydroxide, magnesium hydroxide or a mixture thereof. To the extent acid is added, it is preferably sulphuric acid or paratoluenesulphonic acid.

The mixture of the first resin and the second resin according to the present invention is useful for example in the manufacture of oriented strand board. The mixture of the first resin and the second resin is then mixed with strands of wood and heated under elevated pressure at a temperature of about 130-220° C.

### EXAMPLES

### Example 1

Reference phenol formaldehyde (PF) resin for oriented strandboard (OSB) was prepared in a 5 L glass reactor equipped with pitched blade stirrer. Firstly, 1320 g of molten phenol, 600 g of water and 294 g of NaOH solution (50%) were added to the glass reactor and mixed. Secondly, 1740 g of formaldehyde solution (concentration 52.5%) was added slowly to prevent excessive heat development. The temperature of the reaction mixture was increased to 80° C. and the reaction mixture was continuously stirred for 155 minutes. The reaction mixture was cooled to 60° C. and then 720 g of urea was added to the reaction mixture. The reaction was stopped by cooling to ambient temperature. The reaction was monitored by measuring the viscosity at 25° C. using a Brookfield DV-II+LV viscometer.

The resin was analyzed and the results of the analysis are given in Table 1.

### Example 2

Lignin-phenol-formaldehyde (LPF) resin was synthesized for oriented strandboard (OSB) with a phenol replacement level of 50% with lignin. In the first step, 761 g of powder lignin (solid content 88.5%) and 1090 g of water were added to a 5 L glass reactor at ambient temperature and were stirred until the lignin was fully and evenly dispersed. Then, 326 g of sodium hydroxide solution (50%) was added to the lignin dispersion. The composition was heated to 80° C. and stirred for 60 minutes to make sure that lignin was completely dissolved in the alkaline media. Then, the temperature of the lignin composition was lowered to 45° C.

In the second step, 672 g of phenol, 57 g of sodium hydroxide solution (50%), 24 g of water and 1255 g of formalin solution (52.5%) were added into the reaction mixture. The temperature of the reaction mixture was increased to 80° C. and the reaction mixture was continuously stirred for 190 minutes. The reaction mixture was cooled to 60° C. and then 797 g of urea was added to the reaction mixture. The reaction was stopped by cooling to ambient temperature. The reaction was monitored by measuring the viscosity at 25° C. using a Brookfield DV-II+LV viscometer.

The resin was analyzed and the results of the analysis are given in Table 1.

### Example 3

The resin blend was prepared by mixing PF resin from example 1 and LPF resin from example 2 in a ratio of 1:1 by weight.

The resin blend was analyzed and the results of the analysis are given in Table 1.

### Example 4

The resin blend was prepared by mixing PF resin from example 1 and LPF resin from example 2 in a ratio of 3:1 by weight.

The resin blend was analyzed and the results of the analysis are given in Table 1.

### Example 5

The resin blend was prepared by mixing PF resin from example 1 and LPF resin from example 2 in a ratio of 1:3 by weight.

The resin blend was analyzed and the results of the analysis are given in Table 1.

TABLE 1
Resin properties

| | Resin | Resin | Resin | Resin | Resin |
|---|---|---|---|---|---|
| | from | from | from | from | from |
| | Example 1 | Example 2 | Example 3 | Example 4 | Example 5 |
| Viscosity | 177 | 178 | 181 | 172 | 195 |
| [cP] at | | | | | |
| 25° C. | | | | | |
| pH at 23° C. | 10.3 | 10.5 | 10.4 | 10.3 | 10.4 |
| Solid | 54 | 52.9 | 53.9 | 54.8 | 53.1 |
| Content [%] | | | | | |
| 155° C. | | | | | |
| Gel Time | 26 | 27 | 23 | 22 | 26 |
| at 100° C. | | | | | |

In view of the above detailed description of the present invention, other modifications and variations will become apparent to those skilled in the art. However, it should be apparent that such other modifications and variations may be effected without departing from the spirit and scope of the invention.

### Example 6

Pine wood strands for use as surface layer strands were resinated with the resin from example 5 (8% solid resin on oven dry wood mass) and 1% wax, producing strands with a moisture content of 11% after resination).
For the core layer, pine strands were resinated with 4% pMDI (Suprasec 1561, percentage on oven dry wood mass) and 1% wax producing strands with a moisture content of 4%.
The layer ratio was 2×30%/40% between the surface/core layers. The board was pressed at 190° C. for 13 s/mm with a target thickness of 11.5 mm. The thickness swell and water uptake was measured according to ASTM 1037 point 23 Method B after 24 h immersion in cold water. The internal bond strength was measured according to ASTM1037 point 11, the modulus of rupture and modulus of elasticity were measured according to ASTM 3043 point 8, all after acclimatization at 20° C., 65% r.h for 1 week.

TABLE 2
Board properties

| Board | Thickness | Density | Thickness | Water | Internal | MOR | MOE |
|---|---|---|---|---|---|---|---|
| sample | [mm] | [kg/m³] | swell [%] | uptake [%] | bond [N/mm²] | [N/mm²] | [N/mm²] |
| Resin from | 11.67 | 596 | 21.3 | 39.5 | 0.27 | 23.1 | 4020 |
| example 5 | | | | | | | |

1. A method for preparing a resin in a form of a mixture comprising the steps of:
a) preparing a first resin comprising lignin, phenol, formaldehyde, and a formaldehyde scavenger;
b) preparing a second resin comprising phenol, formaldehyde, and a formaldehyde scavenger, wherein the second resin comprises less than 1 wt-% lignin, by weight of the second resin;
c) mixing the first resin and the second resin in a weight ratio of from 0.5:10 to 10:0.5 based on weight of a mixture of the first resin and the second resin.

2. The method according to claim 1, wherein the mixing in step c) is carried out by stirring at a speed from 20 to 1000 rpm.

3. The method according to claim 1, wherein a duration of the mixing in step at least one minute.

4. The method according to claim 1, wherein the formaldehyde scavenger is urea.

5. A resin in the form of the mixture obtained by the method of claim 1.

6. The method of claim 1 further comprising: manufacturing an oriented strand board with the mixture of the first resin and the second resin.

7. An oriented strand board manufactured using the resin according to claim 5.

8. A method for selecting an optimized resin mixture for a specific end use, the method comprising the steps of:
a) defining one or more desirable properties of a resin;
b) preparing a first resin comprising lignin, phenol, formaldehyde, and a formaldehyde scavenger;
c) preparing a second resin comprising phenol, formaldehyde, and a formaldehyde scavenger, wherein the second resin comprises less than 1 wt-% lignin, by weight of the second resin;
d) mixing the first resin and the second resin in a defined weight ratio of from 0.5:10 to 10:0.5 based on weight of a mixture of the first resin and the second resin;
e) in a different vessel, repeating step d) with a different weight ratio;
repeating step e) at least five times with additional different weight ratios in step d) in each repetition;
g) evaluating properties of each mixture of the first resin and the second resin, said evaluation being carried out based on the properties of the mixture or based on properties of a final product prepared using each mixture of the first resin and the second resin obtained in step f);
h) selecting an optimized mixture of the first resin and the second resin obtained in step f), based on the results of the evaluation carried out in step g), said selection step comprising a determination of which mixture of the first resin and second resin obtained in step f) has properties closest to the one or more desired properties of a resin defined in step a).

9. The method according to claim 2, wherein a duration of the mixing in step c) is at least one minute.

10. The method according to claim 8, wherein the mixing in step d) is carried out by stirring at a speed from 20 to 1000 rpm.

11. The method according to claim 10, wherein a duration of the mixing in step d) is at least one minute.

12. The method according to claim 8, wherein a duration of the mixing in step d) is at least one minute.

13. The method according to claim 8, wherein the formaldehyde scavenger is urea.
